(19) United States
(12) Patent Application Publication
(10) Pub. No.: US 2025/0059081 A1
(43) Pub. Date: Feb. 20, 2025

(54) LITHIUM-CONTAINING LOW THERMAL EXPANSION GLASS

(71) Applicant: CORNING INCORPORATED, CORNING, NY (US)

(72) Inventors: Timothy Michael Gross, Painted Post, NY (US); Jingshi Wu, Painted Post, NY (US)

(21) Appl. No.: 18/783,699

(22) Filed: Jul. 25, 2024

Related U.S. Application Data
(60) Provisional application No. 63/532,696, filed on Aug. 15, 2023.

(51) Int. Cl. C03C 3/093; C03C 1/00

(52) U.S. Cl. CPC C03C 3/093; C03C 1/002; C03C 2204/00

(57) ABSTRACT

An alkali aluminosilicate glass article having: greater than or equal to 70.0 mol % and less than or equal to 78.0 mol % SiO₂; greater than or equal to 7.0 mol % and less than or equal to 12.0 mol % Al₂O₃; greater than or equal to 3.0 mol % and less than or equal to 7.0 mol % B₂O₃; greater than or equal to 2.0 mol % and less than or equal to 7.0 mol % Li₂O; greater than or equal to 3.0 mol % and less than or equal to 6.0 mol % Na₂O; greater than or equal to 0.0 mol % and less than or equal to 2.0 mol % P₂O₅; and greater than or equal to 0.0 mol % and less than or equal to 1.5 mol % REₘOₙ.

This application claims the benefit of priority under 35 U.S.C. § 119 of U.S. Provisional Application Ser. No. 63/532,696 filed on Aug. 15, 2023, the content of which is relied upon and incorporated herein by reference in its entirety.

### BACKGROUND

### Field

The present specification generally relates to alkali aluminosilicate glasses. More specifically, the present specification is directed to lithium-containing alkali aluminosilicate glasses with low thermal expansion that is formed from one hundred percent recycled glass.

### Technical Background

There is currently a push to use less raw materials in all forms of manufacturing, including glass making. To achieve this goal, scrap pieces of glass that go unused during the glass-making process can be recycled by re-melting the scraps in a furnace with raw materials. Indeed, recycling scraps of soda-lime glass to make new soda-lime glass products has been done for years because recycling glasses can make manufacturing new glass products more sustainable and eco-friendly. For instance, it helps reduce pollution and waste; it saves energy used in manufacturing because cullet often melts at a lower temperature; it reduces air pollution and related water pollution that results from producing similar glasses; and it reduces the space in landfills by reducing disposed of cullet. Accordingly, a need exists for technically sophisticated glasses-such as strengthened aluminosilicate glasses—that can be made with recycled materials.

### SUMMARY

The present disclosure is directed to glass compositions having suitable strength and flexibilities for various applications.

Aspect 1 is an alkali aluminosilicate glass article comprising: greater than or equal to 70.0 mol % and less than or equal to 78.0 mol % SiO₂; greater than or equal to 7.0 mol % and less than or equal to 12.0 mol % Al₂O₃; greater than or equal to 3.0 mol % and less than or equal to 7.0 mol % B₂O₃; greater than or equal to 2.0 mol % and less than or equal to 7.0 mol % Li₂O; greater than or equal to 3.0 mol % and less than or equal to 6.0 mol % Na₂O; greater than or equal to 0.0 mol % and less than or equal to 2.0 mol % P₂O₅; and greater than or equal to 0.0 mol % and less than or equal to 1.5 mol % REₘOₙ.

Aspect 2 is an alkali aluminosilicate glass article of aspect 1, further comprising greater than or equal or equal to 0.0 mol % and less than or equal to 1.0 mol % K₂O.

Aspect 3 is an alkali aluminosilicate glass article of any of the preceding aspects, further comprising greater than or equal or equal to 0.0 mol % and less than or equal to 3.0 mol % MgO.

Aspect 4 is an alkali aluminosilicate glass article of any of the preceding aspects, further comprising greater than or equal or equal to 0.0 mol % and less than or equal to 1.0 mol % CaO.

Aspect 5 is an alkali aluminosilicate glass article of any of the preceding aspects, further comprising greater than or equal or equal to 0.0 mol % and less than or equal to 1.0 mol % BaO.

Aspect 6 is an alkali aluminosilicate glass article of any of the preceding aspects, further comprising greater than or equal or equal to 0.0 mol % and less than or equal to 2.0 mol % ZnO.

Aspect 7 is an alkali aluminosilicate glass article of any of the preceding aspects, further comprising greater than or equal or equal to 1.0 mol % and less than or equal to 5.0 mol % RO, wherein RO comprises one or more of MgO, CaO, BaO, or ZnO.

Aspect 8 is an alkali aluminosilicate glass article of any of the preceding aspects, further comprising less than or equal to 1.0 mol % TiO₂.

Aspect 9 is an alkali aluminosilicate glass article of any of the preceding aspects, further comprising less than or equal to 1.0 mol % ZrO₂.

Aspect 10 is an alkali aluminosilicate glass article of any of the preceding aspects, further comprising less than or equal to 0.5 mol % SnO₂.

Aspect 11 is an alkali aluminosilicate glass article of claim 1, further comprising greater than or equal or equal to 10.0 mol % and less than or equal to 14.0 mol % of RO+R₂O, wherein RO comprises one or more of MgO, CaO, BaO, or ZnO, and R₂O comprises one or more of Li₂O, Na₂O, or K₂O.

Aspect 12 is an alkali aluminosilicate glass article of aspect 11, wherein (RO+R₂O)−Al₂O₃ is greater than or equal to 2.0 mol % and less than or equal to 5.0 mol %, wherein RO comprises one or more of MgO, CaO, BaO, or ZnO, and R₂O comprises one or more of Li₂O, Na₂O, or K₂O.

Aspect 13 is an alkali aluminosilicate glass article of aspect 11, wherein a ratio of (RO+R₂O)/Al₂O₃ is greater than or equal to 1.20 and less than or equal to 1.60, wherein RO comprises one or more of MgO, CaO, BaO, or ZnO, and R₂O comprises one or more of Li₂O, Na₂O, or K₂O.

Aspect 14 is an alkali aluminosilicate glass article of any of the preceding aspects, further comprising a ratio of MgO/RO is greater than or equal to 0.4 and less than or equal to 0.8, wherein RO comprises Mg and one or more of CaO, BaO, or ZnO.

Aspect 15 is an alkali aluminosilicate glass article of any of the preceding aspects, wherein the alkali aluminosilicate glass has a melt temperature that is greater than or equal to 1600° C. and less than or equal to 1750° C.

Aspect 16 is an alkali aluminosilicate glass article of any of the preceding aspects, wherein the alkali aluminosilicate glass has an annealing point that is greater than or equal to 540° C. and less than or equal to 630° C.

Aspect 17 is an alkali aluminosilicate glass article of any of the preceding aspects, wherein the alkali aluminosilicate glass has a liquidus temperature that is greater than or equal to 850° C. and less than or equal to 1200° C.

Aspect 18 is an alkali aluminosilicate glass article of any of the preceding aspects, wherein the alkali aluminosilicate glass has a liquidus viscosity that is greater than or equal to 100 kPoise and less than or equal to 3500 kPoise.

Aspect 19 is an alkali aluminosilicate glass article of any of the preceding aspects, wherein the alkali aluminosilicate glass has a coefficient of thermal expansion that is greater than or equal to 40.0×10⁻⁷/° C. and less than or equal to 60.0×10⁻⁷/° C.

Aspect 20 is an alkali aluminosilicate glass article of any of the preceding aspects, wherein the alkali aluminosilicate glass has a Youngs modulus that is greater than or equal to 70.0 GPa and less than or equal to 80.0 GPa.

Aspect 21 is an alkali aluminosilicate glass article of any of the preceding aspects, wherein the alkali aluminosilicate glass is strengthened and has a compressive stress that is greater than or equal to 500 MPa and less than or equal to 900 MPa.

Aspect 22 is an alkali aluminosilicate glass article of any of the preceding aspects, wherein the alkali aluminosilicate glass is strengthened and has a depth of layer that is greater than or equal to 4.0 μm and less than or equal to 15.0 μm.

Aspect 23 is an alkali aluminosilicate glass article of any of the preceding aspects, wherein the alkali aluminosilicate glass article comprises: greater than or equal to 72.0 mol % and less than or equal to 74.5 mol % SiO₂; greater than or equal to 7.5 mol % and less than or equal to 11.1 mol % Al₂O₃; greater than or equal to 3.4 mol % and less than or equal to 6.7 mol % B₂O₃; greater than or equal to 3.4 mol % and less than or equal to 6.6 mol % Li₂O; greater than or equal to 3.2 mol % and less than or equal to 5.1 mol % Na₂O; greater than or equal to 0.0 mol % and less than or equal to 2.0 mol % P₂O₅; and greater than or equal to 0.0 mol % and less than or equal to 1.5 mol % REₘOₙ.

Aspect 24 is an alkali aluminosilicate glass article of any of the preceding aspects, wherein the alkali aluminosilicate glass article comprises: greater than or equal to 72.0 mol % and less than or equal to 74.5 mol % SiO₂; greater than or equal to 7.5 mol % and less than or equal to 11.1 mol % Al₂O₃; greater than or equal to 3.4 mol % and less than or equal to 6.7 mol % B₂O₃; greater than or equal to 3.4 mol % and less than or equal to 6.6 mol % Li₂O; greater than or equal to 3.2 mol % and less than or equal to 5.1 mol % Na₂O; greater than or equal to 0.0 mol % and less than or equal to 2.0 mol % P₂O₅; greater than or equal to 0.0 mol % and less than or equal to 1.5 mol % REₘOₙ; greater than or equal to 0.2 mol % and less than or equal to 0.7 mol % K₂O; greater than or equal to 1.1 mol % and less than or equal to 2.4 mol % MgO; greater than or equal to 0.2 mol % and less than or equal to 0.8 mol % CaO; and greater than or equal to 0.3 mol % and less than or equal to 0.7 mol % ZnO.

Aspect 25 is an alkali aluminosilicate glass article of any of the preceding aspects, wherein the alkali aluminosilicate glass article comprises greater than or equal to 0.03 mol % and less than or equal to 0.05 mol % SnO₂.

Aspect 26 is a consumer electronic device, comprising: a housing having a front surface, a back surface, and side surfaces; electrical components provided at least partially with the housing, the electrical components including at least a controller, a memory, and a display, the display being provided at or adjacent the front surface of the housing; and a glass-based article according to any of the preceding aspects disposed over the display.

Additional features and advantages will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a cross section of a glass having compressive stress layers on surfaces thereof according to embodiments disclosed and described herein;

FIG. 2A schematically depicts an exemplary electronic device incorporating a glass article according to any of the glass articles disclosed and described herein;

FIG. 2B schematically depicts an exemplary electronic device incorporating a glass article according to any of the glass articles disclosed and described herein; and

FIG. 3 is a graph showing measured and calculated compressive stress.

### DETAILED DESCRIPTION

Commercial alkali aluminosilicate glasses are usually not made from recycled glass. The precision required to make compositions that will have all of the desired properties and still be able to be strengthened does not lend itself to being limited to the compositions of the cullet. Moreover, when using cullet it can be difficult to individually to control the amount of one or more oxides without also impacting the amounts of other components in the glass composition. For instance, when making a new glass composition from one hundred percent recycled cullet it can be difficult to raise the amount of, for example, lithium oxide, without also altering the amount of, for example, sodium oxide, because the cullet available will have both component present in pre-determined amounts. Accordingly, it is extremely difficult to be able to balance all of the glass components to get the precise composition required to make a glass that has a desired coefficient of thermal expansion (CTE) so that it is formable by desired methods (such as fusion drawing) and also can be adequately strengthened. For instance, the magnitude of surface compression as well as the depth of compressive stress layer (DOL) play an important role in creating stronger glasses. Taking all of these attributes into consideration while being restricted to compositions of glass cullet results in a unique glass composition that provides a balance of formability and strength.

Reference will now be made in detail to alkali aluminosilicate glasses according to various embodiments. The physical properties of alkali aluminosilicate glasses generally may be related to the glass composition and structure.

In addition, alkali aluminosilicate glasses have good ion exchange ability, and chemical strengthening processes have been used to achieve high strength and high toughness properties in alkali aluminosilicate glasses. Lithium aluminosilicate glasses are highly ion exchangeable glasses with good glass formability and quality. The substitution of Al₂O₃ into the silicate glass network increases the interdiffusivity of monovalent cations during ion exchange. The diffusivity, as measured in diffusion coefficients, is one of the key factors in determining the ion-exchange ability in alkali aluminosilicate glasses, which depends on the glass framework and ion sizes. By chemical strengthening in a molten salt bath (e.g., KNO₃), glasses with high strength and high toughness can be achieved.

Described herein are alkali aluminosilicate glass compositions that may be ion-exchanged to achieve high good compressive stress (CS) at a good depth of layer (DOL), according to embodiments, physical properties of alkali aluminosilicate glass compositions according to embodiments, and ion exchange ability benefits of alkali aluminosilicate glass compositions according to embodiments before and after ion exchange. In addition, glass compositions according to embodiments disclosed and described herein have properties that allow glass sheets to be formed from the glass composition using drawing methods, such as fusion drawing. Glass compositions disclosed and described herein can be formed entirely from recycled glass.

In embodiments of glass compositions described herein, the concentration of constituent components (e.g., SiO₂, Al₂O₃, and the like) are given in mole percent (mol %) on an oxide basis, unless otherwise specified. Components of the alkali aluminosilicate glass composition according to embodiments are discussed individually below. It should be understood that any of the variously recited ranges of one component may be combined with the any of the variously recited ranges for any other component.

According to embodiments, the main glass-forming component is silica (SiO₂), which is the largest constituent of the composition and, as such, is the primary constituent of the resulting glass network. Without being bound to theory, SiO₂ enhances the chemical durability of the glass and, in particular, the resistance of the glass composition to decomposition in acid and the resistance of the glass composition to decomposition in water. If the content of SiO₂ is too low, the chemical durability and chemical resistance of the glass may be reduced and the glass may be susceptible to corrosion. Accordingly, a high SiO₂ concentration is generally desired in embodiments. However, if the content of SiO₂ is too high, the formability of the glass may be diminished as higher concentrations of SiO₂ may increase the difficulty of melting the glass which, in turn, adversely impacts the formability of the glass.

In embodiments, the glass composition generally comprises SiO₂ in an amount greater than or equal to 70.0% and less than or equal to 78.0 mol %. In embodiments, the glass composition comprises SiO₂ in amounts greater than or equal to 72.5 mol % or greater than or equal to 75.0 mol %. In embodiments, the glass composition comprises SiO₂ in amounts less than or equal to 75.0 mol % or less than or equal to 72.5 mol %. In embodiments, the glass composition comprises SiO₂ in an amount greater than or equal and 72.0 mol % and less than or equal and 78.0 mol %, such as greater than or equal to 72.0 mol % and less than or equal to 76.0 mol %, greater than or equal to 72.0 mol % and less than or equal to 74.0 mol %, greater than or equal to 74.0 mol % and less than or equal to 76.0 mol %, or greater than or equal to 76.0 mol % and less than or equal to 78.0 mol %, and all ranges and subranges within the disclosed ranges.

The glass composition of embodiments may further comprise Al₂O₃. Al₂O₃ may serve as a glass network former, similar to SiO₂. Al₂O₃ may increase the viscosity of the glass composition due to its tetrahedral coordination in a glass melt formed from a properly designed glass composition, decreasing the formability of the glass composition when the amount of Al₂O₃ is too high. However, when the concentration of Al₂O₃ is balanced against the concentration of SiO₂ and the concentration of alkali oxides in the glass composition, Al₂O₃ can reduce the liquidus temperature of the glass melt, thereby enhancing the liquidus viscosity and improving the compatibility of the glass composition with certain forming processes, such as the fusion forming process.

In embodiments, the glass composition generally comprises Al₂O₃ in a concentration of greater than or equal to 7.0 mol % and less than or equal to 12.0 mol %, such as greater than or equal to 7.5 mol % and less than or equal to 11.1 mol %, greater than 8.0 mol % and less than or equal to 10.5 mol %, greater than or equal to 8.5 mol % and less than or equal to 10.0 mol %, or greater than or equal to 9.0 mol % and less than or equal to 10.0 mol %.

In embodiments, the glass composition may include boron oxide (B₂O₃). Boron oxide is a flux which may be added to glass compositions to reduce the viscosity of the glass at a given temperature (e.g., the temperature corresponding to the viscosity of 200 poise or a 200 P temperature, at which glass is melted), thereby improving the quality and formability of the glass. The presence of B₂O₃ may also improve scratch resistance of the glass made from the glass composition.

In one or more embodiments, the glass composition comprises B₂O₃ in amounts greater than or equal to 3.0 mol % and less than or equal to 7.0 mol %. In embodiments, the glass composition comprises B₂O₃ in amounts greater than or equal to 3.4 mol %, greater than or equal to 4.0 mol %, greater than or equal to 4.5 mol %, greater than or equal to 5.0 mol %, greater than or equal to 5.5 mol %, greater than or equal to 6.0 mol %, or greater than or equal to 6.5 mol %. In embodiments, the glass composition comprises B₂O₃ in amounts less than 6.5 mol %, such as less than or equal to 6.0 mol %, less than or equal to 5.5 mol %, less than or equal to 5.0 mol %, less than or equal to 4.5 mol %, less than or equal to 4.0 mol %, or less than or equal to 3.5 mol %. In one or more embodiments, glass composition comprises B₂O₃ in amounts greater than or equal to 3.4 mol % and less than or equal to 6.7 mol %, such as greater than or equal to 3.7 mol % and less than or equal to 6.0 mol %, greater than or equal to 4.0 mol % and less than or equal to 5.5 mol %, or greater than or equal to 4.0 mol % and less than or equal to 5.0 mol %.

According to embodiments, the glass composition may also comprise alkali metal oxides, such as Na₂O and Li₂O, for example. The combination of these alkali metal oxides (e.g. Na₂O+Li₂O) may also be referred to as R₂O. In embodiments, the sum of Na₂O and Li₂O is greater than 5 mol %, such as greater than 8 mol %, or greater than 9 mol %. By having a glass composition with this amount of alkali metal oxides, and particularly Na₂O and Li₂O, a deep depth of compression (DOC) and surface compressive stress (CS) may be obtained. In addition, alkali metal oxides, and especially Li₂O, provide short ion-exchange time with high DOC and high central tension (CT).

In embodiments, other alkali metal oxides, such as Rb₂O and Cs₂O, may also be present in the glass compositions. These alkali metal oxides may reduce the liquidus temperature and increase the liquidus viscosity, then preserving the glass forming melt from crystallization at high temperatures. However, these alkali metal oxides can also generate undesirable effects, such as increasing the density and CTE. Therefore, glass compositions of one or more embodiments do not comprise these alkalis.

In embodiments, the glass compositions comprises sodium oxide (Na₂O). The amount of Na₂O in the glass compositions also relates to the ion exchangeability of the glass made from the glass compositions. Specifically, the presence of Na₂O in the glass compositions may increase the ion exchange rate during ion exchange strengthening of the glass by increasing the diffusivity of Na⁺ ions through the glass matrix. Also, Na₂O may suppress the crystallization of alumina containing species, such as spodumene, mullite and corundum and, therefore, decrease the liquidus temperature and increase the liquidus viscosity. However, increasing the Na₂O amount in the glass compositions may increase CTE and worsen the mechanical properties of glass since it decreases the elastic modulus and the fracture toughness, and/or decrease the annealing and strain points of glass. Accordingly, it is desirable in embodiments to limit the amount of Na₂O present in the glass compositions.

In embodiments, the glass composition generally comprises Na₂O in an amount greater than or equal to 3.0 mol % and less than or equal to 6.0 mol %. In embodiments, the glass composition comprises Na₂O in amounts greater than or equal to 3.5 mol % and less than or equal to 5.0 mol %, such as greater than or equal to 3.7 mol % and less than or equal to 4.7 mol %, or greater than or equal to 4.0 mol % and less than or equal to 4.5 mol %.

In one or more embodiments, the glass composition may include lithium oxide (Li₂O). Without being bound by theory, adding Li₂O to a glass composition makes a glass suitable to high-performance ion exchange of lithium ion (Li⁺) for a larger alkali metal ion, such as sodium ion (Na⁺). Since Li⁺ is very small (ionic radius is 0.06 nm), the Li⁺ in the glass can be ion-exchanged very quickly in Na⁺ containing salt bath, and allow to generate compressive stress in short time, and thereby generating a deep DOC in a short time. However, too much Li₂O in the glass can lower glass viscosity and raise glass liquidus temperature, therefore lower the glass liquidus viscosity and cause difficulty for mass production. To achieve good balance between stress profile and ability for manufacturing, it is desirable in embodiments to limit the amount of Li₂O present in the glass compositions.

In embodiments, the glass composition comprises Li₂O in amounts greater than or equal to 2.0 mol % and less than or equal to 7.0 mol %, such as greater than or equal to 2.5 mol % and less than or equal to 6.5 mol %, greater than or equal to 3.0 mol % and less than or equal to 6.0 mol %, greater than or equal to 4.0 mol % and less than or equal to 5.7 mol %, or greater than or equal to 4.5 mol % and less than or equal to 5.7 mol %.

The glass compositions, according to embodiments, may further include potassium oxide (K₂O). The amount of K₂O present in the glass compositions also relates to the ion exchangeability of the glass composition. Specifically, as the amount of K₂O present in the glass composition increases, the compressive stress in the glass obtainable through ion exchange decreases as a result of the exchange of potassium and sodium ions. Also, the potassium oxide, like the sodium oxide, may decrease the liquidus temperature and increase the liquidus viscosity, but at the same time may decrease the elastic modulus and fracture toughness, and may increase CTE. Accordingly, it is desirable to have a limit the amount of K₂O present in the glass compositions.

In embodiments, the glass composition comprises K₂O in amounts greater than or equal to 0.0 mol % and less than or equal to 1.0 mol %. In one or more embodiments, the glass composition comprises K₂O in amounts greater than or equal to 0.2 mol % and less than or equal to 0.8 mol %, such as greater than or equal to 0.3 mol % and less than or equal to 0.7 mol %, greater than or equal to 0.4 mol % and less than or equal to 0.6 mol %, or greater than or equal to 0.4 mol % and less than or equal to 0.5 mol %.

The glass composition may also include alkaline earth metals (RO) according to one or more embodiments. Without being bound by theory, it is believed that adding small amounts of RO to the glass composition decreases the liquidus and high-temperature viscosity of the glass composition thereby improving the formability of the glass composition. However, adding too much RO can result in the glass losing elasticity and becoming more difficult to ion exchange. In embodiments, the glass composition comprises RO in amounts greater than or equal to 1.0 mol % and less than or equal to 5.0 mol %, such as greater than or equal to 1.2 mol % and less than or equal to 4.5 mol %, greater than or equal to 1.5 mol % and less than or equal to 4.0 mol %, greater than or equal to 2.0 mol % and less than or equal to 3.5 mol %, greater than or equal to 2.2 mol % and less than or equal to 3.2 mol %, or greater than or equal to 2.5 mol % and less than or equal to 3.0 mol %.

Glass composition of embodiments may include magnesia (MgO). In the embodiments, it was empirically found that magnesia provides greater increasing the elastic moduli than other divalent metal oxides without providing adverse increase to the density. However, when MgO is added in a high concentration, it can increase the liquidus temperature and cause precipitation of refractory minerals, such as spinel (MgAl₂O₄), forsterite (Mg₂SiO₄) and others, from the glass forming melts at high temperatures. Also, at high concentrations, MgO can slow down the ion exchange. Accordingly, the content of magnesia is limited in embodiments.

According to embodiment, the glass composition comprises MgO in amounts greater than or equal to 0.0 mol % and less than or equal to 3.0 mol %. It should be understood that in embodiments, the glass composition is free of or substantially free of MgO. In embodiments, the glass composition comprises MgO in amounts greater than or equal to 0.5 mol % and less than or equal to 3.0 mol %, such as greater than or equal to 1.0 mol % and less than or equal to 2.5 mol %, greater than or equal to 1.2 mol % and less than or equal to 2.3 mol %, greater than or equal to 1.5 mol % and less than or equal to 2.0 mol %, or greater than or equal to 1.6 mol % and less than or equal to 1.8 mol %.

Glass compositions of embodiments include calcium oxide (CaO). CaO is a flux which may be added to glass compositions to reduce the viscosity of the glass at a given temperature (e.g., the temperature corresponding to the viscosity of 200 poise or a 200 P temperature, at which glass is melted), thereby improving the quality and formability of the glass. Compared with Na₂O, CaO may reduce CTE of the glass. However, too much CaO in a glass composition may decrease the rate of ion exchange in the resultant glass and cause phase separation in high B₂O₃ containing glass. Accordingly, the content of calcium oxide is limited in embodiments.

In embodiments, the glass composition comprises CaO in amounts greater than or equal to 0.0 mol % and less than or equal to 1.0 mol %. It should be understood that in embodiments the glass composition may be free of or substantially free of CaO. In one or more embodiments, the glass composition comprises CaO in amounts greater than or equal to 0.1 mol % and less than or equal to 1.0 mol %, such as greater than or equal to 0.2 mol % and less than or equal to 0.8 mol %, greater than or equal to 0.3 mol % and less than or equal to 0.7 mol %, greater than or equal to 0.3 mol % and less than or equal to 0.6 mol %, greater than or equal to 0.3 mol % and less than or equal to 0.5 mol %, greater than or equal to 0.4 mol % and less than or equal to 0.6 mol %, or greater than or equal to 0.4 mol % and less than or equal to 0.5 mol %.

Glass compositions of embodiments may include barium oxide (BaO). Barium oxide can be added to the glass compositions to reduce the high-temperature viscosity and improve the meltability. However, addition of BaO, even in small concentrations, such as 1 mol % or even less, may significantly decrease the elastic moduli and fracture toughness of glass. BaO increases CTE and the density of glass. Also, it was empirically found that sometimes addition of BaO may increase the liquidus temperature. Accordingly, the content of barium oxide is limited in embodiments.

In embodiments, the glass composition comprises BaO in amounts greater than or equal to 0.0 mol % and less than or equal to 1.0 mol %. It should be understood that in embodiments the glass composition may be free of or substantially free of BaO. In one or more embodiments, the glass composition comprises BaO in amounts greater than or equal to 0.1 mol % and less than or equal to 1.0 mol %, such as greater than or equal to 0.2 mol % and less than or equal to 0.8 mol %, greater than or equal to 0.3 mol % and less than or equal to 0.7 mol %, greater than or equal to 0.3 mol % and less than or equal to 0.6 mol %, greater than or equal to 0.3 mol % and less than or equal to 0.5 mol %, greater than or equal to 0.4 mol % and less than or equal to 0.6 mol %, or greater than or equal to 0.4 mol % and less than or equal to 0.5 mol %.

Glass compositions of embodiments may include zinc oxide (ZnO). Zinc oxide may partially compensate the excess of Al₂O₃, which leads to some suppression of crystallization of mullite and, therefore, reduces the liquidus temperature and increases the liquidus viscosity. At an excess of Al₂O₃, zinc oxide, solely or together with the magnesium oxide, may form spinel that may crystallize at high temperatures and, therefore, in this case ZnO may increase the liquidus temperature and reduce the liquidus viscosity. In addition, a small amount of ZnO (less than 2 mol %) could added into glass to prevent photo darkening from UV light exposure, which sometime is used in glass cleaning process. Accordingly, the content of zinc oxide is limited in embodiments.

In embodiments, the glass composition comprises ZnO in amounts greater than or equal to 0.0 mol % and less than or equal to 2.0 mol %. It should be understood that in embodiments the glass composition may be free of or substantially free of ZnO. In one or more embodiments, the glass composition comprises ZnO in amounts greater than or equal to 0.1 mol % and less than or equal to 1.0 mol %, such as greater than or equal to 0.3 mol % and less than or equal to 0.7 mol %, greater than or equal to 0.3 mol % and less than or equal to 0.6 mol %, greater than or equal to 0.4 mol % and less than or equal to 0.7 mol %, or greater than or equal to 0.4 mol % and less than or equal to 0.5 mol %.

Glass compositions of embodiments may include titania (TiO₂). Titania can be added to the glass composition of the present disclosure to increase the elastic moduli and fracture toughness of glass without significant increase of the density. However, titania may slow down the process of the ion exchange. In addition, a small amount of titania could be added into glass to prevent photo darkening from UV light exposure, which sometime is used in glass cleaning process. However, titania may provide undesirable coloring to the glass. Accordingly, the content of titania is limited in embodiments.

In embodiments, the glass composition comprises TiO₂ in amounts greater than or equal to 0.0 mol % and less than or equal to 1.0 mol %. It should be understood that in embodiments the glass composition may be free of or substantially free of TiO₂. In one or more embodiments, the glass composition comprises TiO₂ in amounts less than or equal to 1.0 mol %, such as less than or equal to 0.5 mol %, less than or equal to 0.2 mol %, or less than or equal to 0.1 mol %.

Glass compositions of embodiments may comprise zirconia (ZrO₂). Zirconia can be added in a small concentrations to the glass compositions of the present disclosure to increase the elastic moduli, fracture toughness and low-temperature viscosity. However, it was empirically found that in the aluminosilicate glasses with high content of alumina, addition of even very small amount of ZrO₂ may increase the liquidus temperature and, therefore, adversely cause crystallization of the refractory minerals, such as zirconia (ZrO₂), zircon (ZrSiO₄) and others, from the glass forming melt at high temperatures. Accordingly, the content of zirconia is limited in embodiments.

In embodiments, the glass composition comprises ZrO₂ in amounts greater than or equal to 0.0 mol % and less than or equal to 1.0 mol %. It should be understood that in embodiments the glass composition may be free of or substantially free of ZrO₂. In one or more embodiments, the glass composition comprises ZrO₂ in amounts less than or equal to 1.0 mol %, such as less than or equal to 0.5 mol %, less than or equal to 0.2 mol %, or less than or equal to 0.1 mol %.

Glass compositions of embodiments may include tin oxide (SnO₂). Tin oxide can be added to the glass compositions of the present disclosure in small concentrations as a fining agent. However, it was empirically found that in some cases, and especially when the content of Al₂O₃ is greater than or equal to the total content of modifiers, the addition of even very small amounts of SnO₂ may cause precipitation of cassiterite (SnO₂) from the melt at high temperatures. Accordingly, the content of tin oxide is limited in embodiments.

In embodiments, the glass composition comprises SnO₂ in amounts greater than or equal to 0.0 mol % and less than or equal to 0.5 mol %. It should be understood that in embodiments the glass composition may be free of or substantially free of SnO₂. In one or more embodiments, the glass composition comprises SnO₂ in amounts less than or equal to 0.5 mol %, such as less than or equal to 0.4 mol %, less than or equal to 0.3 mol %, less than or equal to 0.2 mol %, or less than or equal to 0.1 mol %.

Rare earth metal oxides (REₘOₙ) may be added to the glass compositions of embodiments to provide a number of physical and chemical attributes to the resulting glass article. Rare earth metal oxides refer to the oxides of metals listed in the Lanthanide Series of the IUPAC Periodic Table plus yttrium and scandium. The presence of rare earth metal oxides in the glass composition may increase the modulus, stiffness, or modulus and stiffness of the resultant glass. Rare earth metal oxides may also help to increase the liquidus viscosity of the glass composition. Additionally, certain rare earth metal oxides may add color to the glass. If no color is required or desired, then the glass composition may include lanthanum oxide (La₂O₃), yttrium oxide (Y₂O₃), gadolinium oxide (Gd₂O₃), ytterbium oxide (Yb₂O₃), lutetium oxide (Lu₂O₃), or combinations of these. For colored glasses, the rare earth metal oxides may include Ce₂O₃, Pr₂O₃, Nd₂O₃, Sm₂O₃, Eu₂O₃, Tb₂O₃, Dy₂O₃, Ho₂O₃, Er₂O₃, Tm₂O₃, or combinations of these. Some rare earth metal oxides such as Ce₂O₃ and Gd₂O₃ absorb UV radiation and thus cover glasses containing these oxides can protect OLED display devices from deleterious UV radiation.

Rare earth metal oxides can be added in small concentrations to the glass compositions of the present disclosure for higher elastic moduli, higher fracture toughness and higher low-temperature viscosity, at the same time reducing the high-temperature viscosity of the glass forming melts, which can save energy when melting. However, at high concentrations of REₘOₙ, the liquidus viscosity of glass can be decreased. Also, rare earth metal oxides are comparably expensive, and they may slow down the process of ion exchange. Accordingly, the content of rare earth metal oxides is limited in embodiments.

In embodiments, the glass composition comprises REₘOₙ in amounts greater than or equal to 0.0 mol % and less than or equal to 1.5 mol %. It should be understood that in embodiments the glass composition may be free of or substantially free of REₘOₙ. In one or more embodiments, the glass composition comprises REₘOₙ in amounts greater than or equal to 0.1 mol % and less than or equal to 1.0 mol %, such as greater than or equal to 0.2 mol % and less than or equal to 0.8 mol %, greater than or equal to 0.3 mol % and less than or equal to 0.7 mol %, greater than or equal to 0.3 mol % and less than or equal to 0.6 mol %, greater than or equal to 0.3 mol % and less than or equal to 0.5 mol %, greater than or equal to 0.4 mol % and less than or equal to 0.6 mol %, or greater than or equal to 0.4 mol % and less than or equal to 0.5 mol %.

Glass compositions, according to embodiments, may include phosphorus oxide (P₂O₅). The presence of P₂O₅ increases the liquidus viscosity of the glass compositions by suppressing the crystallization of mullite, spodumene, and some other species (e.g., spinel) from the glass-forming melts when Al₂O₃ (mol %) is greater than R₂O (mol %)+RO (mol %) by more than about 1 mol %. The presence of P₂O₅ in the glass composition compensates the excess Al₂O₃ by decreasing the liquidus temperature, thus increasing the liquidus viscosity of the glass composition. The addition of P₂O₅ allows positive values of Al₂O₃−R₂O−RO up to about 5.0 mol % without significant deterioration of the liquidus viscosity. However, the presence of P₂O₅ tends lower Young's modulus and also increases phase separation in the presence of B₂O₃ and other high field strength modifiers (e.g., MgO and CaO). Accordingly, the content of phosphorus oxide is limited in embodiments.

In embodiments, the amount of P₂O₅ in the glass composition is greater than or equal to 0.0 mol % and less than or equal to 2.0 mol %. It should be understood that in embodiments, the glass composition is free of or substantially free of P₂O₅. In one or more embodiments, the glass composition comprises P₂O₅ in amounts greater than or equal to 0.0 mol % and less than or equal to 2.0 mol %, such as greater than or equal to 0.1 mol % and less than or equal to 1.8 mol %, greater than or equal to 0.2 mol % and less than or equal to 1.5 mol %, greater than or equal to 0.5 mol % and less than or equal to 1.2 mol %, greater than or equal to 0.5 mol % and less than or equal to 1.0 mol %, or greater than or equal to 0.7 mol % and less than or equal to 1.0 mol %.

Without limiting compositions possibly chosen from each of the various components recited above, in embodiments, the glass composition may comprise greater than or equal to 70.0 mol % and less than or equal to 78.0 mol % SiO₂; greater than or equal to 7.0 mol % and less than or equal to 12.0 mol % Al₂O₃; greater than or equal to 3.0 mol % and less than or equal to 7.0 mol % B₂O₃; greater than or equal to 2.0 mol % and less than or equal to 7.0 mol % Li₂O; greater than or equal to 3.0 mol % and less than or equal to 6.0 mol % Na₂O; greater than or equal to 0.0 mol % and less than or equal to 2.0 mol % P₂O₅; and greater than or equal to 0.0 mol % and less than or equal to 1.5 mol % REₘOₙ.

In embodiments, the glass composition may comprise greater than or equal to 72.0 mol % and less than or equal to 74.5 mol % SiO₂; greater than or equal to 7.5 mol % and less than or equal to 11.1 mol % Al₂O₃; greater than or equal to 3.4 mol % and less than or equal to 6.7 mol % B₂O₃; greater than or equal to 3.4 mol % and less than or equal to 6.6 mol % Li₂O; greater than or equal to 3.2 mol % and less than or equal to 5.1 mol % Na₂O; greater than or equal to 0.0 mol % and less than or equal to 2.0 mol % P₂O₅; and greater than or equal to 0.0 mol % and less than or equal to 1.5 mol % REₘOₙ.

In embodiments, the glass composition may comprise greater than or equal to 72.0 mol % and less than or equal to 74.5 mol % SiO₂; greater than or equal to 7.5 mol % and less than or equal to 11.1 mol % Al₂O₃; greater than or equal to 3.4 mol % and less than or equal to 6.7 mol % B₂O₃; greater than or equal to 3.4 mol % and less than or equal to 6.6 mol % Li₂O; greater than or equal to 3.2 mol % and less than or equal to 5.1 mol % Na₂O; greater than or equal to 0.0 mol % and less than or equal to 2.0 mol % P₂O₅; greater than or equal to 0.0 mol % and less than or equal to 1.5 mol % REₘOₙ; greater than or equal to 0.2 mol % and less than or equal to 0.7 mol % K₂O; greater than or equal to 1.1 mol % and less than or equal to 2.4 mol % MgO; greater than or equal to 0.2 mol % and less than or equal to 0.8 mol % CaO; and greater than or equal to 0.3 mol % and less than or equal to 0.7 mol % ZnO.

Without limiting compositions possibly chosen from each of the various components recited above, in embodiments, the glass composition may comprise alkali earth metal oxides (RO) that may include MgO and CaO, wherein the molar ratio of MgO to RO (MgO/RO) may be greater than or equal to 0.4 and less than or equal to 0.8, such as greater than or equal to 0.4 and less than or equal to 0.7, greater than or equal to 0.5 and less than or equal to 0.7, greater than or equal to 0.6 and less than or equal to 0.8, or greater than or equal to 0.6 and less than or equal to 0.7.

In embodiments, the glass composition may comprise alkali earth metal oxides (RO) and alkali metal oxides (R₂O), wherein the sum of the mole percentage of RO and R₂O (RO+R₂O) may be greater than or equal to 10.0 mol % and less than or equal to 14.0 mol %, such as greater than or equal to 11.0 mol % and less than or equal to 13.5 mol %, or greater than or equal to 11.5 mol % and less than or equal to 13.5 mol %. In embodiments, the glass composition may comprise RO, R₂O, and Al₂O₃, wherein the sum of the mole percentage of RO and R₂O minus the mole percentage of Al₂O₃ ((RO+R₂O)−Al₂O₃) may be greater than or equal to 2.0 mol % and less than or equal to 5.0 mol %, such as greater than or equal to 2.5 mol % and less than or equal to 4.0 mol %, or greater than or equal to 3.0 mol % and less than or equal to 4.0 mol %. In embodiments, the glass composition may comprise RO, R₂O, and Al₂O₃, wherein the sum of mole percentage of RO and R₂O over the mole percentage of Al₂O₃ ((RO+R₂O)/Al₂O₃) may be greater than or equal to 1.20 and less than or equal to 1.60, such as greater than or equal to 1.25 and less than or equal to 1.55, greater than or equal to 1.30 to less than or equal to 1.50, or greater than or equal to 1.35 and less than or equal to 1.45.

As discussed above, alkali aluminosilicate glass compositions disclosed and described herein comprise a significant amount of cullet, which allows for a large proportion of the alkali aluminosilicate glasses disclosed and described herein to be from post-consumer recycled material. According to one or more embodiments, the alkali aluminosilicate glasses disclosed and described herein are made from one hundred percent recycled cullet. Accordingly, methods for making glass compositions according to embodiments disclosed and described herein include melting two or more different types of cullet to achieve a homogeneous mixture of the melted cullet having a glass composition as disclosed and described hereinabove.

Physical properties of alkali aluminosilicate glass compositions as disclosed and described herein will now be discussed.

The density of the glass compositions was determined using the buoyancy method of ASTM C693-93(2013). Glass compositions according to embodiments may have a density that is greater than or equal to 2.30 g/cm³ and less than or equal to 2.37 g/cm³, such as greater than or equal to 2.33 g/cm³ and less than or equal to 2.36 g/cm³, greater than or equal to 2.33 g/cm³ and less than or equal to 2.35 g/cm³, greater than or equal to 2.34 g/cm³ and less than or equal to 2.36 g/cm³, or greater than or equal to 2.34 g/cm³ and less than or equal to 2.35 g/cm³.

The term “strain point,” as used herein, refers to the temperature at which the viscosity of the glass composition is 1×10^{14.68} poise. The strain point of the glass compositions was determined using the fiber elongation method of ASTM C336-71(2015). In embodiments, the strain point of glass compositions may be greater than or equal to 500° C. and less than or equal to 575° C., such as greater than or equal to 510° C. and less than or equal to 570° C., greater than or equal to 520° C. and less than or equal to 560° C., greater than or equal to 530° C. and less than or equal to 550° C., or greater than or equal to 540° C. to less than or equal to 560° C.

The term “annealing point,” as used herein, refers to the temperature at which the viscosity of the glass composition is 1×10^{13.18} poise. The annealing point of the glass compositions was determined using the fiber elongation method of ASTM C336-71(2015). In embodiments, the annealing point of glass compositions may be greater than or equal to 540° C. and less than or equal to 630° C., such as greater than or equal to 550° C. and less than or equal to 620° C., greater than or equal to 560° C. and less than or equal to 610° C., greater than or equal to 570° C. and less than or equal to 610° C., greater than or equal to 560° C. and less than or equal to 610° C., or greater than or equal to 580° C. and less than or equal to 610° C., or greater than or equal to 580° C. and less than or. In embodiments, the annealing point of the glass composition may be from greater than or equal to 630° C. to less than or equal to 670° C.

The term “softening point,” as used herein, refers to the temperature at which the viscosity of the glass composition is 1×10^{7.6} poise. The softening point of the glass compositions was determined using the fiber elongation method of ASTM C338-93(2008). In embodiments, the softening point of glass compositions is greater than or equal to 800° C. and less than or equal to 900° C., such as greater than or equal to 810° C. and less than or equal to 890° C., greater than or equal to 820° C. and less than or equal to 880° C., or greater than or equal to 830° C. and less than or equal to 870° C.

According to embodiments, the CTE of a glass article may determine the possible changes of the linear size of the substrate caused by temperature changes. The less the CTE, the less temperature-induced deformation. This property is measured by using a horizontal dilatometer (push-rod dilatometer) in accordance with ASTM E228-11. In embodiments, the CTE of the glass composition may be greater than or equal to 40.0×10⁻⁷/° C. and less than or equal to 60.0×10⁻⁷/° C., such as greater than or equal to 42.0×10⁻⁷/° C. and less than or equal to 58.0×10⁻⁷/° C., greater than or equal to 44.0×10⁻⁷/° C. and less than or equal to 56.0×10⁻⁷/° C., greater than or equal to 46.0×10⁻⁷/° C. and less than or equal to 54.0×10⁻⁷/° C., greater than or equal to 48.0×10⁻⁷/° C. and less than or equal to 52.0×10⁻⁷/° C., or greater than or equal to 49.0×10⁻⁷/° C. and less than or equal to 51.0×10⁻⁷/° C.

Formula (1) below can be used to design a glass composition with the CTE disclosed above:

$$CTE = \sum {α}_{i} {x}_{i} \qquad ( 1 )$$

where αᵢ is mean linear expansion coefficients for cation polyhedral i (αᵢ for some cations are listed in Table 1), and xᵢ is molar fraction of the i oxide. For B₂O₃, there are two values, the lower one is for three coordinated boron (^{[3]}B) and the higher one is for four coordinated boron (^{[4]}B). In multi-component glass, the fraction of ^{[4]}B (N₄) can be estimated by the following formula (2):

$${N}_{4} = ( {x}_{{R}_{2} O} + {x}_{RO} - {x}_{{Al}_{2} {O}_{3}} ) / {x}_{{B}_{2} {O}_{3}} \qquad ( 2 )$$

where x_{R}_{₂}_{O} represent total molar fraction of alkali metal oxides, x_{RO} represent total molar fraction of divalent cation oxides, x_{Al}_{₂}_{O}_{₃} is molar fraction of Al₂O₃, and x_{B}_{₂}_{O}_{₃} is molar fraction of B₂O₃. If (x_{R}_{₂}_{O}+x_{RO}−x_{Al}_{₂}_{O}_{₃})/x_{B}_{₂}_{O}_{₃}<0, all boron cations are ^{[3]}B, so N₄=0. If (x_{R}_{₂}_{O}+x_{RO}−x_{Al}_{₂}_{O}_{₃})/x_{B}_{₂}_{O}_{₃}>1, all boron cations are ^{[4]}B, so N₄=1.

TABLE 1
Mean linear expansion coefficients for cation polyhedral

| Cation | | | | | | | | | | | | |
|---|---|---|---|---|---|---|---|---|---|---|---|---|
| oxides | SiO₂ | Al₂O₃ | B₂O₃ | Li₂O | Na₂O | K₂O | MgO | CaO | ZnO | TiO₂ | La₂O₃ | ZrO₂ |
| αᵢ | 40 | 53 | 40 (^{[3]}B) | 160 | 240 | 320 | 100 | 120 | 100 | 60 | 107 | 60 |
| (×10⁻⁷/° C.) | | | or 53 | | | | | | | | | |
| | | | (^{[4]}B) | | | | | | | | | |

The Poisson's ratio (v), the Young's modulus (E), and the shear modulus (G) of the glass compositions were measured by a resonant ultrasonic spectroscopy technique of the general type set forth in ASTM E2001-13, titled “Standard Guide for Resonant Ultrasound Spectroscopy for Defect Detection in Both Metallic and Non-metallic Parts.”

Embodiments of glass compositions also have high elastic modulus (i.e., the ratio of the force exerted upon a substance or body to the resultant deformation). High elastic modulus makes a glass article more rigid and allows it to avoid large deformations under an external force that may take place. The most common of stiffness of a material is the Young's modulus, (i.e., the relationship between stress (force per unit area) and strain (proportional deformation) in an article made of this material). The higher the Young's modulus of material, the less the deformation.

In embodiments, the Young's modulus of a glass composition may be greater than or equal to 70.0 GPa and less than or equal to 80.0 GPa, such as greater than or equal to 72.0 GPa and less than or equal to 78.0 GPa, greater than or equal to 74.0 GPa and less than or equal to 76.0 GPa.

According to embodiments, the glass composition may have a shear modulus that is greater than or equal to 29.0 GPa and less than or equal to 31.5 GPa, such as greater than or equal to 29.5 GPa and less than or equal to 31.0 GPa, from greater than or equal to 30.0 GPa and less than or equal to 30.5 GPa.

According to embodiments, the glass composition may have a Poisson's ratio that is greater than or equal to 0.200 and less than or equal to 0.210, such as greater than or equal to 0.201 and less than or equal to 0.208, or greater than or equal to 0.202 and less than or equal to 0.206.

The glass compositions described herein may be selected to have liquidus viscosities that are compatible with fusion draw processes. Thus, the glass compositions described herein are compatible with existing forming methods, increasing the manufacturability of glass-based articles formed from the glass compositions. As used herein, the term “liquidus viscosity” refers to the viscosity of a molten glass at the liquidus temperature, wherein the liquidus temperature refers to the temperature at which crystals first appear as a molten glass cools down from the melting temperature, or the temperature at which the very last crystals melt away as temperature is increased from room temperature. Unless specified otherwise, a liquidus viscosity value disclosed in this application is determined by the following method. First, the liquidus temperature of the glass is measured in accordance with ASTM C829-81 (2015), titled “Standard Practice for Measurement of Liquidus Temperature of Glass by the Gradient Furnace Method.” Next, the viscosity of the glass above the softening point is measured in accordance with ASTM C965-96 (2012), titled “Standard Practice for Measuring Viscosity of Glass Above the Softening Point”. The term “Vogel-Fulcher-Tamman (‘VFT’) relation,” as used herein, described the temperature dependence of the viscosity and is represented by the following equation log η=A+B/(T−T₀), where n is viscosity. To determine VFT A, VFT B, and VFT T₀, the viscosity of the glass composition is measured over a given temperature range. The raw data of viscosity versus temperature is then fit with the VFT equation by least-squares fitting to obtain A, B, and T₀. With these values, a viscosity point (e.g., 200 P Temperature, 35000 P Temperature, and 200000 P Temperature) at any temperature above softening point may be calculated. Unless otherwise specified, the liquidus viscosity and temperature of a glass composition or article is measured before the composition or article is subjected to any ion-exchange process or any other strengthening process. In particular, the liquidus viscosity and temperature of a glass composition or article is measured before the composition or article is exposed to an ion-exchange solution, for example before being immersed in an ion-exchange solution. Where an ion exchanged article is described as having a liquidus viscosity, the reference is to the liquidus viscosity of the article prior to ion exchange. The pre-ion exchange composition may be determined by looking at the composition at the center of the article.

According to embodiments, the glass composition may be melted at a temperature corresponding to the viscosity of 200 Poises (200 P temperature). The relationship between the viscosity and temperature of a glass-forming melt is, essentially, a function of chemical composition of the glass that is melted. The glass viscosity was measured by the rotating crucible method according to ASTM C965-96 (2017).

According to embodiments, the glass composition may have a liquidus temperature of that is greater than or equal to 850° C. and less than or equal to 1200° C., such as greater than or equal to 1000° C. and less than or equal to 1150° C., greater than or equal to 1025° C. and less than or equal to 1125° C., or greater than or equal to 1050° C. and less than or equal to 1100° C. In embodiments, the liquidus temperature of the glass composition is greater than or equal to 1000° C. and less than or equal to 1175° C., such as greater than or equal to 1025° C. and less than or equal to 1175° C., greater than or equal to 1050° C. and less than or equal to 1175° C., greater than or equal to 1075° C. and less than or equal to 1175° C., greater than or equal to 1100° C. and less than or equal to 1175° C., greater than or equal to 1125° C. and less than or equal to 1175° C., or greater than or equal to 1150° C. and less than or equal to 1175° C.

The liquidus viscosity of the glass compositions, according to embodiments, is greater than or equal to 100 kPa and less than or equal to 3500 kPa, such as greater than or equal to 125 kPa and less than or equal to 2500 kPa, greater than or equal to 150 kPa and less than or equal to 1800 kPa, greater than or equal to 200 kPa and less than or equal to 1600 kPa, greater than or equal to 400 kPa and less than or equal to 1400 kPa, greater than or equal to 700 kPa and less than or equal to 1200 kPa, or greater than or equal to 900 kPa and less than or equal to 1000 kPa.

Glass compositions according to embodiments have a melt temperature (or 200 poise temperature) that is greater than or equal to 1600° C. and less than or equal to 1750° C., such as greater than or equal to 1650° C. and less than or equal to 1750° C., greater than or equal to 1675° C. and less than or equal to 1750° C., greater than or equal to 1675° C. and less than or equal to 1725° C., greater than or equal to 1700° C. and less than or equal to 1750° C., or greater than or equal to 1700° C. and less than or equal to 1725° C.

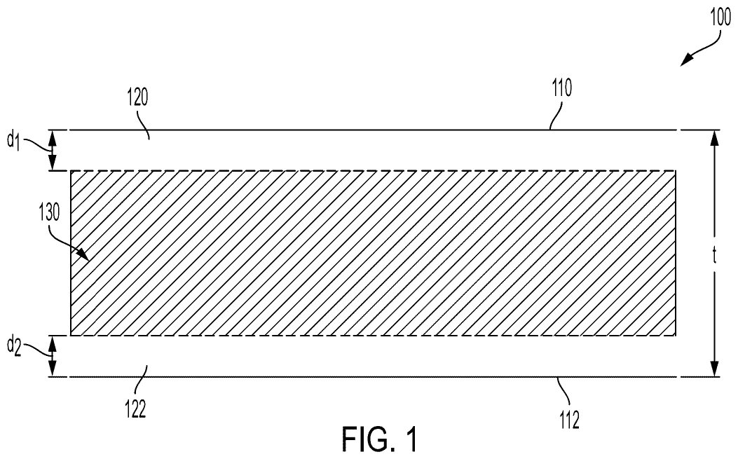

As mentioned above, in embodiments, the alkali aluminosilicate glass compositions can be strengthened, such as by ion exchange, making a glass that is damage resistant for applications such as, but not limited to, cover glasses and digital screens. With reference to FIG. 1, the glass has a first region under compressive stress (e.g., first and second compressive layers 120, 122 in FIG. 1) extending from the surface to a depth of layer DOL of the glass and a second region (e.g., central region 130 in FIG. 1) under a tensile stress or central tension CT extending from the depth of layer into the central or interior region of the glass.

“Peak compressive stress,” as used herein, refers to the highest compressive stress (CS) value measured within a compressive stress region. The CS has a maximum at the surface of the glass, and the CS varies with distance d from the surface according to a function. Referring again to FIG. 1, a first segment 120 extends from first surface 110 to a depth d₁ and a second segment 122 extends from second surface 112 to a depth d₂. Together, these segments define a surface compression or surface CS of glass 100. In embodiments, the surface CS may be from greater or equal to 500 MPa to less than or equal to 900 MPa. In embodiments, the surface CS may be at least 500 MPa, at least 550 MPa, at least 600 MPa, at least 650 MPa, at least 675 MPa, at least 700 MPa, at least 725 MPa, at least 750 MPa, at least 775 MPa, at least 800 MPa, at least 825 MPa, at least 850 MPa, at least 875 MPa, at least 900 MPa, at least 925 MPa, at least 950 MPa, or at least 975 MPa. In embodiments, the surface CS may be greater than or equal to 525 MPa and less than or equal to 850 MPa, such as greater than or equal to 550 MPa and less than or equal to 800 MPa, greater than or equal to 575 MPa and less than or equal to 750 MPa, greater than or equal to 600 MPa and less than or equal to 725 MPa, or greater than or equal to 650 MPa and less than or equal to 750 MPa.

Depth of layer” (DOL), as used herein, refers to the depth within a glass article at which an ion of a metal oxide diffuses into the glass article where the concentration of the ion reaches a minimum value. The depth of layer DOL-after being ion exchanged in a single molten salt for less than 2 hours—of each of first and second compressive layers 120, 122 may be greater than or equal to 4.0 μm and less than or equal to 15.0 μm, such as greater than or equal to 5.0 μm and less than or equal to 12.5 μm, greater than or equal to 6.0 μm and less than or equal to 12.0 μm, greater than or equal to 7.0 μm and less than or equal to 11.5 μm, greater than or equal to 8.0 μm and less than or equal to 11.0 μm, or from greater than or equal to 9.0 μm and less than or equal to 10.5 μm.

According to embodiments, the surface compressive stress after ion-exchange may be calculated based on experiences with a 100% molten KNO₃ bath, at 430° C. for 1.5 hours using the following formula (3):

$$CS = \sum {G}_{i} {x}_{i} \cdot ( {B}_{Li - K} {C}_{Li - K} + {B}_{Na - K} {C}_{Na - K} ) \qquad ( 3 )$$

where Gᵢ is dissociation energy of the i oxide (ref. 2), and ΣGᵢxᵢ is a good proxy for Young's modulus. The unit of Gᵢ and ΣGᵢxᵢ is kJ/cm³, which is equal to GPa. The Gᵢ values for the oxides are listed in Table 2 below, and there are two values for B₂O₃ depending on the boron coordination state. The parameter B in eqn. (3) is the network dilation coefficient, which gives the linear strain per unit change in alkali concentration. Based on the ionic radius differences between Li⁺ (0.59 Å), Na⁺ (1.02 Å), and K⁺ (1.51 Å), it is estimated that B_{Na-K} is 900 ppm/mol and B_{Li-K} is 1690 ppm/mol. C_{Na-K} represents the concentration of Na₂O replaced by K₂O near the surface of the glass. It is assumed 90% of Na₂O would is replaced by K₂O in a 100% KNO₃ bath at 430° C. with 1.5 hours duration, and it results in C_{Na-K}=90% x_{Na}_{₂}_{O}; it is also assumed 60% of Li₂O would have been replaced by K₂O at the same condition because the ionic radius difference between the two is larger, the interdiffusion would be less likely to happen, and it results in C_{Li-K}=60% x_{Li}_{₂}_{O}.

TABLE 2
Disassociation energy of oxides

| Cation oxides | SiO₂ | Al₂O₃ | B₂O₃ | Li₂O | Na₂O | K₂O | MgO | CaO | ZnO |
|---|---|---|---|---|---|---|---|---|---|
| Gᵢ (kJ/cm³, or | 68 | 131 | 15.6 (^{[3]}B) | 77.9 | 31.9 | 19.2 | 90 | 64.1 | 49.9 |
| GPa) | | | or 82.8 | | | | | | |
| | | | (^{[4]}B) | | | | | | |

As noted above, compressive stress layers may be formed in the glass by exposing the glass to an ion exchange solution. In embodiments, the ion exchange solution may be molten nitrate salts or molten sulfate salts. In embodiments, the ion exchange solution may be molten KNO₃, molten NaNO₃, or combinations thereof. In certain embodiments, the ion exchange solution may comprise about 100% molten KNO₃.

The glass composition may be exposed to the ion exchange solution by dipping a glass article made from the glass composition into a bath of the ion exchange solution, spraying the ion exchange solution onto a glass article made from the glass composition, or otherwise physically applying the ion exchange solution to a glass article made from the glass composition. Upon exposure to the glass composition, the ion exchange solution may, according to embodiments, be at a temperature from greater than or equal to 380° C. to less than or equal to 450° C., such as from greater than or equal to 385° C. to less than or equal to 445° C., from greater than or equal to 390° C. to less than or equal to 440° C., from greater than or equal to 395° C. to less than or equal to 435° C., from greater than or equal to 400° C. to less than or equal to 430° C., from greater than or equal to 405° C. to less than or equal to 425° C., or from greater than or equal to 410° C. to less than or equal to 420° C. In embodiments, the glass composition may be exposed to the ion exchange solution for a duration from greater than or equal to 1 hour to less than or equal to 8 hours, such as from greater than or equal to 2 hours to less than or equal to 7 hours, or from greater than or equal to 3 hours to less than or equal to 6 hours.

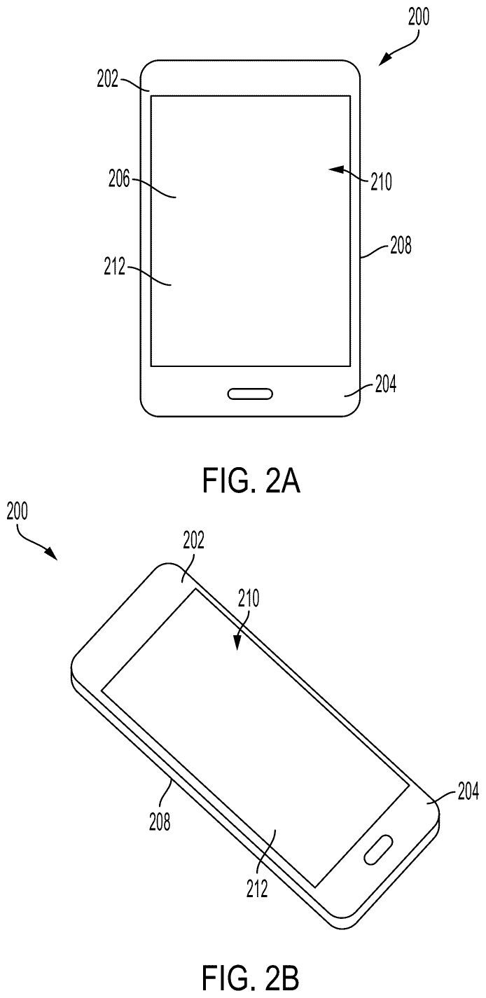

The glass articles made from the glass compositions disclosed herein may be incorporated into another article, for example an article with a display (or display articles) (e.g., consumer electronics, including mobile phones, watches, tablets, computers, navigation systems, and the like), architectural articles, transportation articles (e.g., automobiles, trains, aircraft, sea craft, etc.), appliance articles, or any article that may benefit from some transparency, scratch-resistance, abrasion resistance or a combination thereof. An exemplary article incorporating any of the glass articles disclosed herein is shown in FIG. 2. Specifically, FIG. 2 shows a consumer electronic product 200 including a housing 202 having a front surface 204, a back surface 206, and side surfaces 208. A display 210, for example, a light emitting diode (LED) display or an organic light emitting diode (OLED) display, is at least partially inside the housing 202. A cover substrate 212 may be disposed at or over front surface 204 of housing 202 such that it is disposed over display 210. Cover substrate 212 may include any of the glass articles made from the glass compositions disclosed herein. Cover substrate 212 may serve to protect display 210 and other components of consumer electronic product 200 from damage. In embodiments, cover substrate 212 may be bonded to display 210 with an adhesive. In embodiments, cover substrate 212 may define all or a portion of front surface 204 of housing 202. In some embodiments, cover substrate 212 may define front surface 204 of housing 202 and all or a portion of side surfaces 208 of housing 202.

### EXAMPLES

Embodiments will be further clarified by the following examples. It should be understood that these examples are not limiting to the embodiments described above.

Cullet was collected so that when batched and melted together the cullet has the composition shown in Table 3 below. After the batch materials are melted, it is desirable avoid crystallization when forming a glass sheet, ribbon, or other articles from the said melt. For glass-forming substances, the main numerical characteristic of the crystallization process is the liquidus temperature (TL), which specifies the minimum temperature above which a material is completely liquid, and the maximum temperature at which crystals can co-exist with the melt in thermodynamic equilibrium. This property is measured by the gradient method. This method conforms to ASTM C829-81 Standard Practices for Measurement of Liquidus Temperature of Glass. Accordingly, the glass forming process normally takes place at the temperature higher than TL. On the other hand, the liquidus viscosity of the glass composition can be used to determine which forming processes that can be used to make glass into a sheet is determined by the liquidus viscosity. The greater the liquidus viscosity the more forming processes will be compatible with the glass. Since glass viscosity decreases exponentially with temperature, it is desirable to keep the liquidus temperature as low as possible to maximize the viscosity at the liquidus. For float processing, the glass composition generally has a liquidus viscosity of at least 10 kP, and the fusion process requires a liquidus viscosity of at least 50 kP, such as at least 100 kP, or at least 500 kP. For other processes, such as hot pressing, twin-rollers technique, etc. the viscosity value may be considerably lower. For example, for hot pressing that is used on occasion in optical industry, a liquidus viscosity of 10 to 20 poises may be satisfactory.

TABLE 3
Glass compositions and properties

| | | E1 | E2 | E3 | E4 | E5 | E6 |
|---|---|---|---|---|---|---|---|
| SiO₂ | | 74.03 | 74.40 | 73.29 | 73.13 | 72.83 | 72.63 |
| Al₂O₃ | | 8.41 | 7.51 | 8.80 | 9.24 | 9.69 | 10.15 |
| B₂O₃ | | 5.77 | 6.65 | 5.44 | 4.99 | 4.60 | 4.17 |
| Li₂O | | 4.07 | 3.45 | 4.94 | 5.26 | 5.64 | 5.93 |
| Na₂O | | 4.60 | 5.01 | 4.36 | 4.13 | 3.91 | 3.71 |
| K₂O | | 0.59 | 0.69 | 0.53 | 0.48 | 0.43 | 0.38 |
| MgO | | 1.46 | 1.18 | 1.59 | 1.74 | 1.88 | 2.02 |
| CaO | | 0.63 | 0.75 | 0.57 | 0.51 | 0.45 | 0.39 |
| ZnO | | 0.41 | 0.33 | 0.44 | 0.48 | 0.53 | 0.57 |
| SnO₂ | | 0.03 | 0.03 | 0.04 | 0.04 | 0.04 | 0.04 |
| density (g/cm³) | | 2.338 | 2.334 | 2.341 | 2.345 | 2.348 | 2.353 |
| Measured CTE | | 51.6 | 51.4 | 51.3 | 51.1 | 50.9 | 49.8 |
| (×10⁻⁷/° C.) | | | | | | | |
| Strain Point (° C.) | | 520 | 513 | 525 | 532 | 541 | 551 |
| annealing Point (° C.) | | 565 | 556 | 572 | 580 | 590 | 601 |
| softening Point (° C.) | | 826.8 | 802.7 | 837.6 | 849.9 | 859.8 | 869.2 |
| RI @ 589.3 nm | | 1.495 | 1.493 | 1.496 | 1.501 | 1.500 | 1.501 |
| SOC (nm/mm/MPa) | | 3.375 | 3.388 | 3.359 | 3.337 | 3.328 | 3.289 |
| Poisson's Ratio | | 0.202 | 0.201 | 0.204 | 0.202 | 0.208 | 0.207 |
| shear modulus (GPa) | | 30.3 | 30.0 | 30.5 | 30.8 | 30.9 | 31.2 |
| Young's modulus | | 72.9 | 72.0 | 73.4 | 73.8 | 74.7 | 75.4 |
| (GPa) | | | | | | | |
| VFT | A | −3.821 | −2.923 | −3.104 | −3.821 | −3.664 | −3.65 |
| parameters | B | 12118.7 | 9794.7 | 9884.2 | 11730.3 | 11010 | 10798.1 |
| | T₀ | −259.8 | −139.9 | −94.3 | −202.7 | −137.1 | −123.9 |
| 200 P temp (° C.) | | 1720 | 1735 | 1734 | 1713 | 1709 | 1691 |
| 35000 P temp (° C.) | | 1189 | 1172 | 1198 | 1200 | 1204 | 1194 |
| 100000 P temp (° C.) | | 1114 | 1096 | 1125 | 1127 | 1134 | 1124 |
| 200000 P temp (° C.) | | 1069 | 1051 | 1082 | 1083 | 1091 | 1082 |
| Liquidus Temp (° C.) | | 950 | <900 | 980 | 990 | 1015 | 1040 |
| Liquidus viscosity | | 1571 | >3132 | 1249 | 1033 | 781 | 424 |
| (kPoise) | | | | | | | |
| | | | | | CE | CE | CE |
| | | E7 | E8 | CE9 | 10 | 11 | 12 |
| SiO₂ | | 72.40 | 72.10 | 75.49 | 75.84 | 76.36 | 77.37 |
| Al₂O₃ | | 10.59 | 11.04 | 6.69 | 5.74 | 4.89 | 4.03 |
| B₂O₃ | | 3.78 | 3.45 | 7.33 | 8.19 | 8.81 | 9.64 |
| Li₂O | | 6.28 | 6.59 | 2.21 | 1.72 | 1.25 | 0.00 |
| Na₂O | | 3.47 | 3.26 | 5.46 | 5.87 | 6.22 | 6.65 |
| K₂O | | 0.32 | 0.27 | 0.79 | 0.88 | 0.95 | 1.03 |
| MgO | | 2.17 | 2.32 | 0.90 | 0.60 | 0.33 | 0.05 |
| CaO | | 0.34 | 0.27 | 0.87 | 0.99 | 1.10 | 1.23 |
| ZnO | | 0.61 | 0.65 | 0.25 | 0.16 | 0.08 | 0.00 |
| SnO₂ | | 0.05 | 0.05 | 0.02 | 0.01 | 0.01 | 0.00 |
| density (g/cm³) | | 2.358 | 2.363 | 2.331 | 2.33 | 2.329 | 2.331 |
| Measured CTE | | 50.2 | 49 | 51.9 | 51.9 | 52.3 | 51.6 |
| (×10⁻⁷/° C.) | | | | | | | |
| Strain Point (° C.) | | 558 | 566 | 509 | 513 | 521 | 537 |
| annealing Point (° C.) | | 609 | 618 | 551 | 554 | 562 | 580 |
| softening Point (° C.) | | 874.8 | 884.8 | 789.2 | 778.8 | 783 | 794.8 |
| RI @ 589.3 nm | | 1.496 | 1.498 | 1.492 | 1.491 | 1.490 | 1.490 |
| SOC (nm/mm/MPa) | | 3.264 | 3.229 | 3.406 | 3.432 | 3.442 | 3.465 |
| Poisson's Ratio | | 0.205 | 0.208 | 0.2 | 0.198 | 0.195 | 0.192 |
| shear modulus (GPa) | | 31.6 | 32.0 | 29.8 | 29.7 | 29.5 | 29.4 |
| Young's modulus | | 76.3 | 77.3 | 71.4 | 71.2 | 70.5 | 70.1 |
| (GPa) | | | | | | | |
| VFT | A | −3.449 | −3.402 | −3.062 | −1.838 | −1.442 | −1.077 |
| parameters | B | 10060.9 | 9618 | 10502.1 | 7113.1 | 6062.4 | 4968.7 |
| | T₀ | −64 | 2.2 | −219.1 | 10.2 | 83.6 | 218 |

| | | | | | | |
|---|---|---|---|---|---|---|
| 200 P temp (° C.) | 1686 | 1689 | 1739 | 1729 | 1703 | 1689 |
| 35000 P temp (° C.) | 1195 | 1213 | 1162 | 1125 | 1096 | 1102 |
| 100000 P temp (° C.) | 1127 | 1147 | 1084 | 1050 | 1025 | 1036 |
| 200000 P temp (° C.) | 1086 | 1107 | 1037 | 1007 | 983 | 997 |
| Liquidus Temp (° C.) | 1085 | 1125 | 870 | 905 | 900 | 980 |
| Liquidus viscosity | 203 | 146 | 3810 | 1292 | 963 | 278 |
| (kPoise) | | | | | | |

The calculated CTE from Equation (1) and N₄ calculated from Equation (2) are listed in Table 4 and Table 5 below. The calculated CTE shows good agreement with measured CTE for the comparative examples CE1 and CE2 (Table 4), however such calculated CTE is higher than measured CTE for the examples and comparative examples listed in Table 3. It is believed that the mean linear expansion coefficients for cation polyhedral αᵢ listed in Table 1 are more accurate on predict CTE for the glasses depolymerized with non-bridging oxygens (NBOs), such as CE1 and CE2. As modifier cation oxides, e.g. R₂O and RO, added to the glass, they tend to charge balance trivalent network forming cations such as Al³⁺ and B³⁺ first. If any access modifier cations left, e.g. x_{R}_{₂}_{O}+x_{RO}−x_{Al}_{₂}_{O}_{₃}−x_{B}_{₂}_{O}_{₃}>0, they will depolymerize the glass network by forming NBOs. All the examples in Table 3 have x_{R}_{₂}_{O}+x_{RO}−x_{Al}_{₂}_{O}_{₃}−x_{B}_{₂}_{O}_{₃}<0, therefore the glasses have no NBOs. And in such case, the calculated CTE from Equation (1) is overestimated and it is higher than the measured value. Nevertheless, when the calculated CTE is less than 60×10⁻⁷/° C., it is still a good indicator for the measured CTE less than 60×10⁻⁷/° C. as shown in Table 3 and Table 5. The comparative examples in Table 4 shows that CTE will be higher than the desirable values when either Li₂O or Na₂O is higher than our claimed composition range. Since the alkali metal oxides have the highest αᵢ, we want to limit the concentration of them. However, to protect the glass from sharp contact damage, we need certain amount of Li₂O and Na₂O for obtaining disable surface CS after ion-exchange. As predicted by Equation (3), when the Li₂O is low as shown by the comparative examples listed in Table 3, e.g. CE9, CE10, CE11 and CE12, the calculated surface CS (listed in Table 5) is lower than 500 MPa.

TABLE 4
Comparative examples of glass compositions and properties

| | CE1 | CE1 | CE2 |
|---|---|---|---|
| | wt % | mol % | mol % |
| SiO₂ | 66.8 | 70.37 | 71 |
| Al₂O₃ | 11.3 | 7.01 | 9 |
| B₂O₃ | 3.4 | 3.09 | 4 |
| Li₂O | 2.5 | 5.30 | 7.8 |
| Na₂O | 7 | 7.15 | 3.6 |
| CaO | 3 | 3.39 | 0 |
| K₂O | 2.5 | 1.68 | 0.6 |
| TiO₂ | 1.9 | 1.51 | 0 |
| La₂O₃ | 0.7 | 0.14 | 0 |
| ZrO₂ | 0.6 | 0.31 | 0 |
| ZnO | | 0.00 | 1.6 |
| MgO | | 0.00 | 2.4 |
| N₄ | | 1 | 1 |

| | | |
|---|---|---|
| Measured CTE (×10⁻⁷/° C.) | 68.3 | 63.5 |
| Calculated CTE (×10⁻⁷/° C.) | 69.8 | 62.3 |

TABLE 5
Example and comparative example glass calculated properties

| | E1 | E2 | E3 | E4 | E5 | E6 | E7 | E8 | CE9 | CE10 | CE11 | CE12 |
|---|---|---|---|---|---|---|---|---|---|---|---|---|
| N₄ | 0.58 | 0.58 | 0.67 | 0.68 | 0.68 | 0.69 | 0.69 | 0.67 | 0.52 | 0.55 | 0.57 | 0.51 |
| Calculated CTE (×10⁻⁷/° C.) | 58.9 | 59.1 | 59.4 | 59.3 | 59.2 | 59.1 | 59.0 | 58.9 | 58.5 | 58.8 | 59.0 | 58.3 |
| Calculated Σ Gᵢxᵢ (GPa) | 71 | 70 | 72 | 73 | 73 | 73 | 74 | 74 | 69 | 68 | 67 | 66 |
| Calculated CS (MPa) | 559 | 531 | 615 | 630 | 649 | 663 | 679 | 693 | 459 | 441 | 424 | 354 |

Glass articles from Table 3 can be ion-exchanged in single component salt bath, such as 100% KNO₃. Table 6 and Table 7 were analyzed for compressive stress (CS) and depth of layer (DOL) from FSM with corresponding salt bath and ion-exchange duration. In the table, possible variation in CS values can be ±25 MPa and DOL variation can be ±0.2 μm, due to precision limitations of the metrology. All the glasses used for ion-exchange are 1 mm thick.

TABLE 6
FSM measured CS and DOL after ion-exchange in 100%
KNO₃ bath at 380° C. and 410° C.

| | | IOX temperature | | | | | |
|---|---|---|---|---|---|---|---|
| | | 380° C. | | | 410° C. | | |
| | | IOX time (hour) | | | | | |
| | | 1 | 4 | 9 | 1 | 4 | 9 |
| E1 | CS (MPa) | 610 | 562 | 568 | 563 | 548 | 533 |
| | DOL (μm) | 5 | 10 | 14 | 8 | 15 | 21 |
| E2 | CS (MPa) | 549 | 502 | 507 | 514 | 481 | 475 |
| | DOL (μm) | 5 | 10 | 14 | 8 | 14 | 21 |

TABLE 7
FSM measured CS and DOL after ion-exchange in 100% KNO₃ bath at 430° C.

| IOX time | | | | | | | | | | | | | |
|---|---|---|---|---|---|---|---|---|---|---|---|---|---|
| (hour) | | E1 | E2 | E3 | E4 | E5 | E6 | E7 | E8 | CE9 | CE10 | CE11 | CE12 |
| 0.5 | CS | 568 | 512 | 594 | 599 | 681 | 740 | 759 | 837 | 466 | 435 | 399 | 380 |
| | (MPa) | | | | | | | | | | | | |
| | DOL | 6 | 6 | 7 | 7 | 6 | 6 | 6 | 5 | 6 | 6 | 6 | 6 |
| | (μm) | | | | | | | | | | | | |
| 1 | CS | 559 | 508 | 559 | 578 | 601 | 724 | 717 | 803 | 453 | 408 | 378 | 337 |
| | (MPa) | | | | | | | | | | | | |
| | DOL | 9 | 9 | 10 | 10 | 9 | 8 | 8 | 7 | 9 | 9 | 9 | 9 |
| | (μm) | | | | | | | | | | | | |
| 1.5 | CS | 554 | 498 | 560 | 566 | 589 | 679 | 701 | 798 | 437 | 389 | 363 | 334 |
| | (MPa) | | | | | | | | | | | | |
| | DOL | 11 | 11 | 12 | 11 | 11 | 11 | 10 | 9 | 11 | 11 | 10 | 10 |
| | (μm) | | | | | | | | | | | | |

Compressive stress (including surface CS) after ion exchange was measured by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured at 546.1 nm according to Procedure C (Glass Disc Method) described in ASTM standard C770-16, entitled “Standard Test Method for Measurement of Glass Stress-Optical Coefficient”.

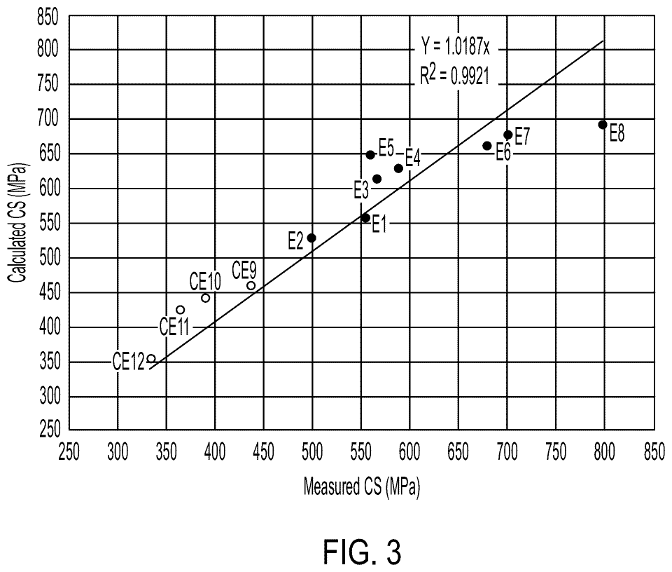

The measured CS (1.5 hours condition) from Table 7 agrees well with the calculated CS as shown in FIG. 3, which is a graph showing measured CS after the glass is ion-exchanged in a 100% KNO₃ bath at 430° C. for 1.5 hours vs calculated CS from Equation (3). FIG. 1 shows that both measured CS and calculated CS for the comparative examples are below 500 MPa.

The term “Knoop Scratch Threshold” refers to the onset of lateral cracking. In Knoop threshold testing, a mechanical tester holds a Knoop diamond in which a glass is scratched at increasing loads to determine the onset of lateral cracking. As used herein, Knoop Scratch Threshold is the onset of lateral cracking (3 or more of 5 indentation events). In Knoop Scratch Lateral Cracking Threshold testing, samples of the glass articles and articles were first scratched with a Knoop indenter under a dynamic or ramped load to identify the lateral crack onset load range for the sample population. Once the applicable load range is identified, a series of increasing constant load scratches (3 minimum or more per load) are performed to identify the Knoop Scratch Threshold. Knoop Scratch Threshold range can be determined by comparing the test specimen to one of the following 3 failure modes: 1) sustained lateral surface cracks that are more than two times the width of the groove, 2) damage is contained within the groove, but there are lateral surface cracks that are less than two times the width of groove and there is damage visible by naked eye, or 3) the presence of large subsurface lateral cracks which are greater than two times the width of groove and/or there is a median crack at the vertex of the scratch.

In some embodiments, the glasses described herein, when ion exchanged as detailed above, may exhibit Knoop scratch thresholds (KST) are in a range from about 8 Newtons (N) to about 14 N as shown in Table 8 below.

TABLE 8
Knoop scratch thresholds after the glasses went through an ion exchange in 100% KNO₃ bath

| Glass | E1 | E1 | E1 | E2 | E2 | E2 | E3 | E3 | E4 | E6 |
|---|---|---|---|---|---|---|---|---|---|---|
| IOX temp | 380 | 410 | 430 | 380 | 410 | 430 | 430 | 430 | 430 | 430 |
| (° C.) | | | | | | | | | | |
| IOX time | 4 | 2 | 1.5 | 4 | 2 | 1.5 | 1 | 1.5 | 1.5 | 1.5 |
| (Hour) | | | | | | | | | | |
| KST | 8N-10N | 12N-14N | 8N-10N | 8N-10N | 8N-10N | 8N-10N | 8N-10N | 8N-10N | 12N-14N | 12N-14N |
| results | | | | | | | | | | |

What is claimed is:

1. An alkali aluminosilicate glass article comprising:
greater than or equal to 70.0 mol % and less than or equal to 78.0 mol % SiO₂;
greater than or equal to 7.0 mol % and less than or equal to 12.0 mol % Al₂O₃;
greater than or equal to 3.0 mol % and less than or equal to 7.0 mol % B₂O₃;
greater than or equal to 2.0 mol % and less than or equal to 7.0 mol % Li₂O;
greater than or equal to 3.0 mol % and less than or equal to 6.0 mol % Na₂O;
greater than or equal to 0.0 mol % and less than or equal to 2.0 mol % P₂O₅; and
greater than or equal to 0.0 mol % and less than or equal to 1.5 mol % REₘOₙ.

2. The alkali aluminosilicate glass article of claim 1, further comprising greater than or equal or equal to 0.0 mol % and less than or equal to 1.0 mol % K₂O.

3. The alkali aluminosilicate glass article of claim 1, further comprising greater than or equal or equal to 0.0 mol % and less than or equal to 3.0 mol % MgO.

4. The alkali aluminosilicate glass article of claim 1, further comprising greater than or equal or equal to 0.0 mol % and less than or equal to 1.0 mol % CaO.

5. The alkali aluminosilicate glass article of claim 1, further comprising greater than or equal or equal to 0.0 mol % and less than or equal to 1.0 mol % BaO.

6. The alkali aluminosilicate glass article of claim 1, further comprising greater than or equal or equal to 0.0 mol % and less than or equal to 2.0 mol % ZnO.

7. The alkali aluminosilicate glass article of claim 1, further comprising greater than or equal or equal to 1.0 mol % and less than or equal to 5.0 mol % RO, wherein RO comprises one or more of MgO, CaO, BaO, or ZnO.

8. The alkali aluminosilicate glass article of claim 1, further comprising less than or equal to 1.0 mol % TiO₂.

9. The alkali aluminosilicate glass article of claim 1, further comprising less than or equal to 1.0 mol % ZrO₂.

10. The alkali aluminosilicate glass article of claim 1, further comprising less than or equal to 0.5 mol % SnO₂.

11. The alkali aluminosilicate glass article of claim 1, further comprising greater than or equal or equal to 10.0 mol % and less than or equal to 14.0 mol % of RO+R₂O, wherein
RO comprises one or more of MgO, CaO, BaO, or ZnO, and
R₂O comprises one or more of Li₂O, Na₂O, or K₂O.

12. The alkali aluminosilicate glass article of claim 11, wherein (RO+R₂O)−Al₂O₃ is greater than or equal to 2.0 mol % and less than or equal to 5.0 mol %, wherein
RO comprises one or more of MgO, CaO, BaO, or ZnO, and
R₂O comprises one or more of Li₂O, Na₂O, or K₂O.

13. The alkali aluminosilicate glass article of claim 11, wherein a ratio of (RO+R₂O)/Al₂O₃ is greater than or equal to 1.20 and less than or equal to 1.60, wherein
RO comprises one or more of MgO, CaO, BaO, or ZnO, and
R₂O comprises one or more of Li₂O, Na₂O, or K₂O.

14. The alkali aluminosilicate glass article of claim 1, further comprising a ratio of MgO/RO that is greater than or equal to 0.4 and less than or equal to 0.8,
wherein RO comprises Mg and one or more of CaO, BaO, or ZnO.

15. The alkali aluminosilicate glass article of claim 1, wherein the alkali aluminosilicate glass has a melt temperature that is greater than or equal to 1600° C. and less than or equal to 1750° C.

16. The alkali aluminosilicate glass article of claim 1, wherein the alkali aluminosilicate glass has an annealing point that is greater than or equal to 540° C. and less than or equal to 630° C.

17. The alkali aluminosilicate glass article of claim 1, wherein the alkali aluminosilicate glass has a liquidus temperature that is greater than or equal to 850° C. and less than or equal to 1200° C.

18. The alkali aluminosilicate glass article of claim 1, wherein the alkali aluminosilicate glass has a liquidus viscosity that is greater than or equal to 100 kPoise and less than or equal to 3500 kPoise.

19. The alkali aluminosilicate glass article of claim 1, wherein the alkali aluminosilicate glass has a coefficient of thermal expansion that is greater than or equal to 40.0×10⁻⁷/° C. and less than or equal to 60.0×10⁻⁷/° C.

20. The alkali aluminosilicate glass article of claim 1, wherein the alkali aluminosilicate glass has a Youngs modulus that is greater than or equal to 70.0 GPa and less than or equal to 80.0 GPa.

21. The alkali aluminosilicate glass article of claim 1, wherein the alkali aluminosilicate glass is strengthened and has a compressive stress that is greater than or equal to 500 MPa and less than or equal to 900 MPa.

22. The alkali aluminosilicate glass article of claim 1, wherein the alkali aluminosilicate glass is strengthened and has a depth of layer that is greater than or equal to 4.0 μm and less than or equal to 15.0 μm.

23. The alkali aluminosilicate glass article of claim 1, wherein the alkali aluminosilicate glass article comprises:
greater than or equal to 72.0 mol % and less than or equal to 74.5 mol % SiO₂;
greater than or equal to 7.5 mol % and less than or equal to 11.1 mol % Al₂O₃;
greater than or equal to 3.4 mol % and less than or equal to 6.7 mol % B₂O₃;
greater than or equal to 3.4 mol % and less than or equal to 6.6 mol % Li₂O;
greater than or equal to 3.2 mol % and less than or equal to 5.1 mol % Na₂O;
greater than or equal to 0.0 mol % and less than or equal to 2.0 mol % P₂O₅; and
greater than or equal to 0.0 mol % and less than or equal to 1.5 mol % REₘOₙ.

24. The alkali aluminosilicate glass article of claim 1, wherein the alkali aluminosilicate glass article comprises:
greater than or equal to 72.0 mol % and less than or equal to 74.5 mol % SiO₂;
greater than or equal to 7.5 mol % and less than or equal to 11.1 mol % Al₂O₃;
greater than or equal to 3.4 mol % and less than or equal to 6.7 mol % B₂O₃;
greater than or equal to 3.4 mol % and less than or equal to 6.6 mol % Li₂O;
greater than or equal to 3.2 mol % and less than or equal to 5.1 mol % Na₂O;
greater than or equal to 0.0 mol % and less than or equal to 2.0 mol % P₂O₅;
greater than or equal to 0.0 mol % and less than or equal to 1.5 mol % REₘOₙ;
greater than or equal to 0.2 mol % and less than or equal to 0.7 mol % K₂O;
greater than or equal to 1.1 mol % and less than or equal to 2.4 mol % MgO;
greater than or equal to 0.2 mol % and less than or equal to 0.8 mol % CaO; and
greater than or equal to 0.3 mol % and less than or equal to 0.7 mol % ZnO.

25. The alkali aluminosilicate glass article of claim 24, wherein the alkali aluminosilicate glass article comprises greater than or equal to 0.03 mol % and less than or equal to 0.05 mol % SnO₂.

26. A consumer electronic device, comprising:
a housing having a front surface, a back surface, and side surfaces;
electrical components provided at least partially with the housing, the electrical components including at least a controller, a memory, and a display, the display being provided at or adjacent the front surface of the housing; and
a glass-based article according to any preceding claim disposed over the display.
